(19) United States
(12) Patent Application Publication
(10) Pub. No.: US 2006/0282875 A1
(43) Pub. Date: Dec. 14, 2006

(54) Digital cable adapter

(76) Inventors: Terry Glatt, Pompano Beach, FL (US); Neil Gaydon, Boca Raton, FL (US); Graham Williams, Delray Beach, FL (US); Derrick Fitzgerald, Marietta, GA (US); David Novak, Lakeworth, FL (US); Matthew Grabham, Delray Beach, FL (US)

Correspondence Address: BLANK ROME LLP, 600 NEW HAMPSHIRE AVENUE, N.W., WASHINGTON, DC, 20037, US

(21) Appl. No.: 10/557,708

(22) PCT Filed: May 19, 2004
(86) PCT No.: PCT/US04/15744

§ 371 Date: Nov. 22, 2005

Related U.S. Application Data
(60) Provisional application No. 60/472,413, filed on May 22, 2003.
(60) Provisional application No. 60/475,001, filed on Jun. 3, 2003.

(51) Int. Cl. G06F 3/00; H04N 7/16

(52) U.S. Cl. 725/151; 710/8

(57) ABSTRACT

An in-line digital cable television adapter and method for receiving and converting digital television signals to an analog format for display on an analog television set. Dual-capable video decryption and decoding is available to support a television, VCR, and a picture-in-picture independently and simultaneously. Dual-BTSC audio and video frequency modulators are available for output. A bypass switch selectively switches between television channels for modulation and for passing an analog supplied television signal directly to the analog television set. An infrared transceiver integrated with the digital cable adapter receives infrared frequencies from a compatible infrared remote control and stimulates input to a target infrared receiver.

### REFERENCE TO RELATED APPLICATION

The present application claims the benefit of U.S. Provisional Patent Application No. 60/472,413, filed on May 22, 2003, and U.S. Provisional Patent Application No. 60/475,001, filed on Jun. 3, 2003, whose disclosures are hereby incorporated by reference in their entireties into the present disclosure.

### FIELD OF THE INVENTION

The present invention is generally related to digital cable television, and, more particularly, is related to an apparatus and method for viewing digital cable television on a conventional analog television set.

### DESCRIPTION OF RELATED ART

Analog television will be phased out by 2006 in favor of digital television, which has advantages such as a greater number of channels in a given bandwidth. There is thus a need to provide consumers with a transition from analog to all-digital broadcasting.

However, analog television set consumers will most likely resent having to buy new equipment within a narrow time window to take advantage of digital television. Also, in a switch-over solution, to enjoy wide acceptance, the solution must take into account the existence of video cassette recorders and picture-in-picture televisions. Furthermore, a television with such capabilities built in requires that the user purchase a new television set.

Another difficulty with traditional cable television set-top boxes is their radial design, i.e., all connections are on the same surface of the set-top box. That design imposes limitations on the placement of the set-top box. Thus, a heretofor unaddressed need exists in the industry to address the aforementioned deficiencies and inadequacies.

### SUMMARY OF THE INVENTION

Embodiments of the present invention provide an in-line digital cable adapter (DCA) and method for allowing digital cable television signals to be viewed on a conventional analog television set. The adapter includes a 3/4/Analog-bypass switch. The switch allows the output to be sent to channel 3 or 4, as is known in the art, and also adds a novel feature in that if the input is analog, the digital to analog conversion can be bypassed, so that the input and output are both analog. Thus, when the time comes to switch from analog to digital inputs, the customer can simply flip the switch accordingly.

This invention allows an MSO to deploy the DCA to all of its analog cell subscribers and have them run in analog bypass mode. The MSO would then identify its subscribers of the “Digital Cutover Date” on which the subscribers would switch to digital mode. The converted programming output will be compatible with analog televisions and VCR's using channel 3 or 4 modulation. Alternatively, the switch can be software-controlled, and the MSO can send a signal to actuate the switch.

In one embodiment, the claimed invention provides a secondary path for independent VCR support with integrated use of a single infrared (IR) transceiver. This is important to the successful transition to all digital networks due to the number of VCRs coupled with televisions and the requirement to offer an exact substitution for the functionality that analog consumers have with analog cable television and their TVs and VCRs.

The mechanical utility of the coaxial/in-line application of the digital cable adapter is that its design is in-line with the coaxial cable that provides the cable television source. This allows flexibility to the connection to the television and VCR, the cable wall outlet, and a needed alternating current (AC) power outlet. To accomplish this advantage, the infrared transceiver either is integrated in the structure of the digital cable adapter or can be designed as a tethered attachment. The infrared transceiver is located near the front or ‘faces’ of the television and VCR for exposure to a compatible infrared remote control. The infrared transceiver simulates the VCR infrared input. The infrared transceiver can also be replaced with any other suitable technology, such as a radio frequency (RF) transceiver.

In other embodiments of the claimed invention, the following features may be included:

dual-capable video decryption and decoding to support a TV and VCR or picture-in-picture (PIP) independently and simultaneously;

dual-BTSC Audio and RF modulators;

TV/VCR relationship for integration of the dual path technology described above;

a graphical user interface (GUI) for VCR control (this can be based on existing GUIs for VCR control, which are well known in the art and therefore will not be disclosed in detail here, however, their use in the context of the claimed invention is novel);

an infrared transceiver for receiving remote control commands from a remote control while simultaneously providing control to the VCR unit; and

the ability to select the modulation channel (3 or 4, and so forth) for digital mode or analog bypass.

Other systems, methods, features, and advantages of the present invention will be or become apparent to one skilled in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

A preferred embodiment of the present invention and variations thereof will be set forth in detail with reference to the drawings, in which:

FIG. 1 is a functional block diagram of an embodiment of the digital cable adapter;

FIGS. 2A and 2B are reduced fit block diagrams of modifications of the digital cable adapter of FIG. 1 where the outputs have been reduced to 2 and 1 RF modulated outputs, respectively;

FIGS. 3A and 3B illustrate a proposed layout arrangement of components in the digital cable adapter of FIG. 1;

FIGS. 4A-4D illustrate perspective drawings of an assembly of the digital cable adapter of FIG. 1; and

FIG. 5 is a perspective drawing of an embodiment of the invention with a removable circuitry component.

### DETAILED DESCRIPTION OF THE PREFERRED EMBODIMENT

A preferred embodiment of the invention and modifications thereof will now be described with reference to the drawings, in which like reference numerals refer to like elements throughout.

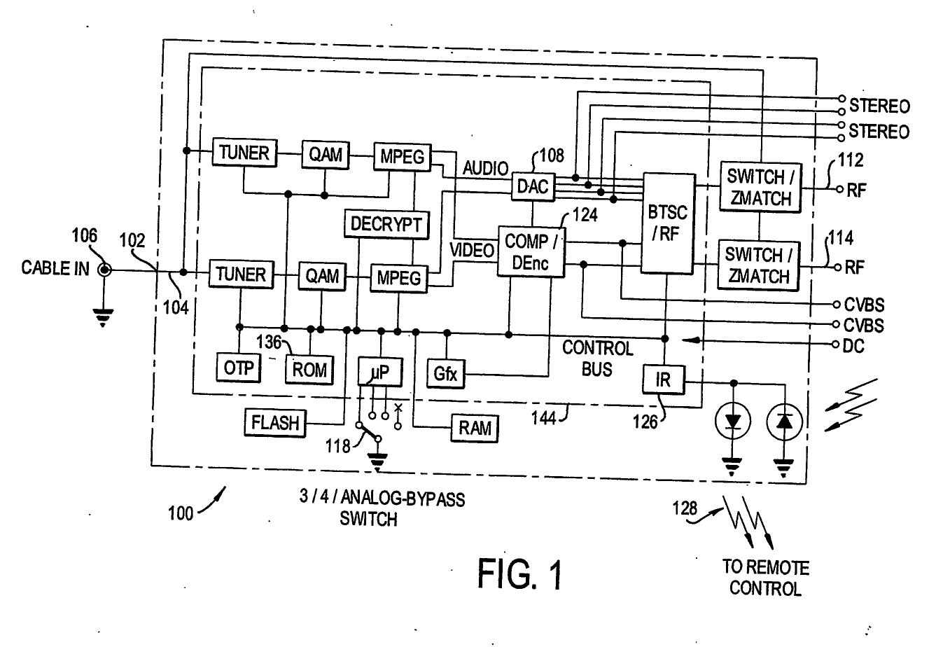

FIG. 1 illustrates a functional block diagram of the DCA. In practice, some of the components may or may not be fitted for use.

In this disclosure and the drawings, it will be understood that disclosures of specific standards, protocols, and the like are illustrative rather than limiting. For example, while the disclosed preferred embodiments may use quadrature amplitude modulation (QAM), MPEG decoding, and the like, the invention as broadly defined uses a modulation technique such as QAM, a decoding technique such as MPEG, etc. Of course, if the digital cable adapter is manufactured for use outside the United States, the standards appropriate for the country of intended use are used.

The DCA 100 is connected to the Cable TV source 106 through which either analog or digital television signals 104 are delivered to an input 102. If the network still delivers analog services, a switch 118 (3/4/Analog-bypass switch) is set to Analog-bypass, and the DCA 100 will act as a splitter/impedance matching circuit and pass the analog television signals through to the TV and VCR outputs (for connection to suitable display, recording, or other devices). Once the network delivers only digital services, the switch 118 is set to either channel 3 or 4 for modulated operation. A first circuitry 108 converts the digital television signals to an analog format for output to analog TVs and VCRs. In a Fully-Featured DCA, base band outputs could be available so that un-modulated video and audio can be provided to base band inputs of TVs and VCRs.

Using a companion remote control with a TV/VCR (or A/B) switch, the user selects which of the two paths is being controlled (TV or VCR, A or B, etc.) and selects the channel to be QAM demodulated and MPEG decoded for output via the RF or base band outputs. It should be noted that a DCA 100 can be envisioned that has more than two channel capability.

Memory, such as programmable memory 136 (one-time programmable or reprogrammable), provides for security information (keys/certificates) to be programmed into the DCA 100 during manufacture, or in the field to enable a conditional access scheme once the DCA 100 is deployed on a network. The addition of small form-factor security cards (e.g., SIM format) would also enable content protection. In order to allow control of a VCR, a graphical user interface (GUI) (not shown) is provided which will give the user the ability to schedule the recording of a program on a VCR connected to the DCA 100; for example, by setting Start, Stop, Date, and Channel information. The graphical user interface (not shown) will also allow for other user information, for example channel number and call letters, time of day, etc.

To receive infrared (IR) control signals 128 from a remote control (not shown) and to transmit IR control sequences to the VCR, an IR Transceiver 126 is defined. The IR Transceiver 126 will transmit commands such as a Record and Stop command pair to the VCR's IR input at the appropriate Start and Stop times, respectively. This IR Transceiver 126 can be removably attached via a tether wire (not shown) and plug/jack pair (not shown) or integrated into the unit. Multiple conductors will be employed on the IR connector jack to allow a (serial) data interface (not shown) to the sealed production unit for test, diagnostics, and upgrades using a special service cable.

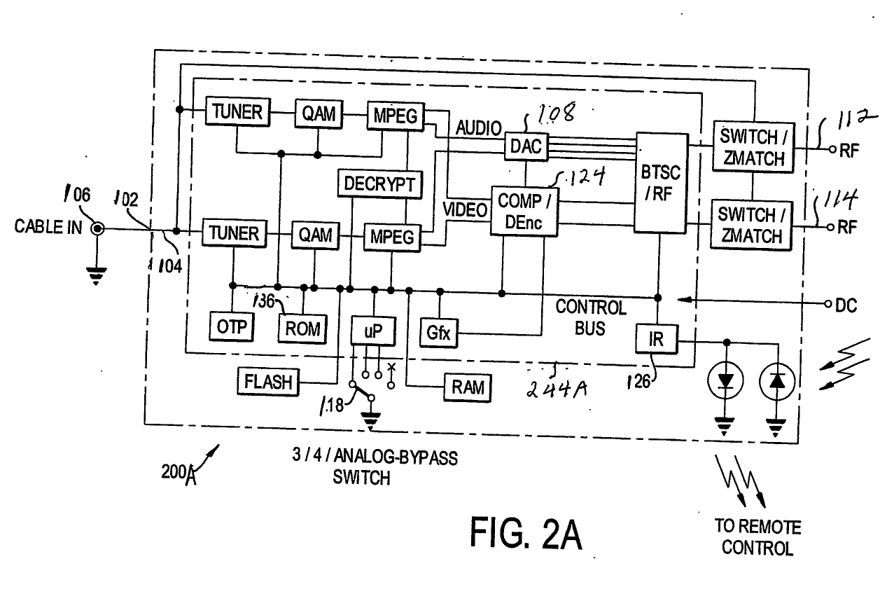

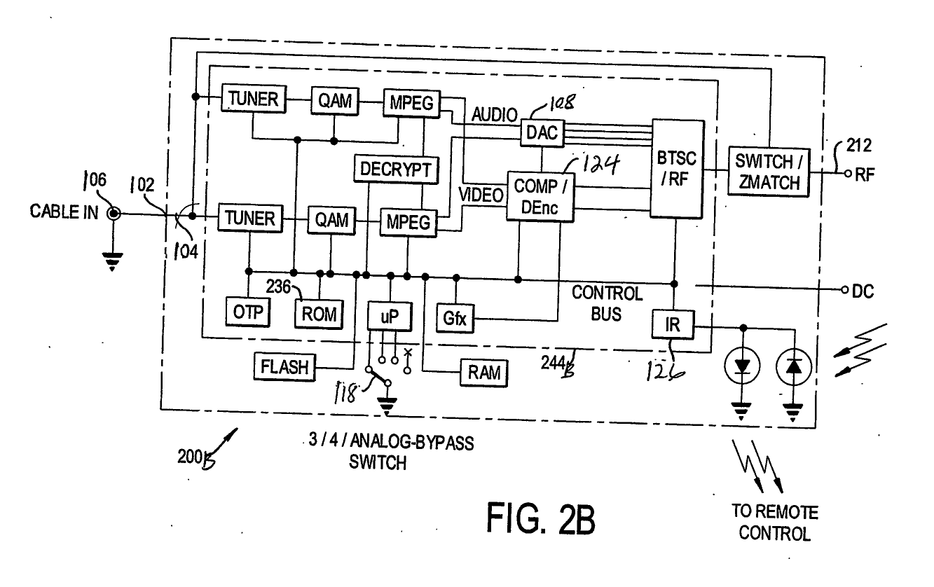

The reduced-fit version 200A or 200B of the DCA shown in FIG. 2A or 2B is the likely deployed embodiment where the outputs have been reduced to first and second RF modulated outputs 112, 114, respectively, or to a single RF modulated output 212. Any modification to the DCA 100 taught in the present specification may be made to the DCA 200A or 200B, insofar as is technologically feasible. A fuller explanation of the single output 212 will be given below.

In other embodiments of the DCA 100, 200A or 200B as actually implemented, variations of silicon integration are possible. For example, tuners may not be in the integrated chip (IC) 144, 244A, or 244B. Also, the IR Transceiver functionality may be integrated in the housing of the DCA 100, 200A or 200B via PCB-mounted components with openings/lenses provided instead of the tether wire concept.

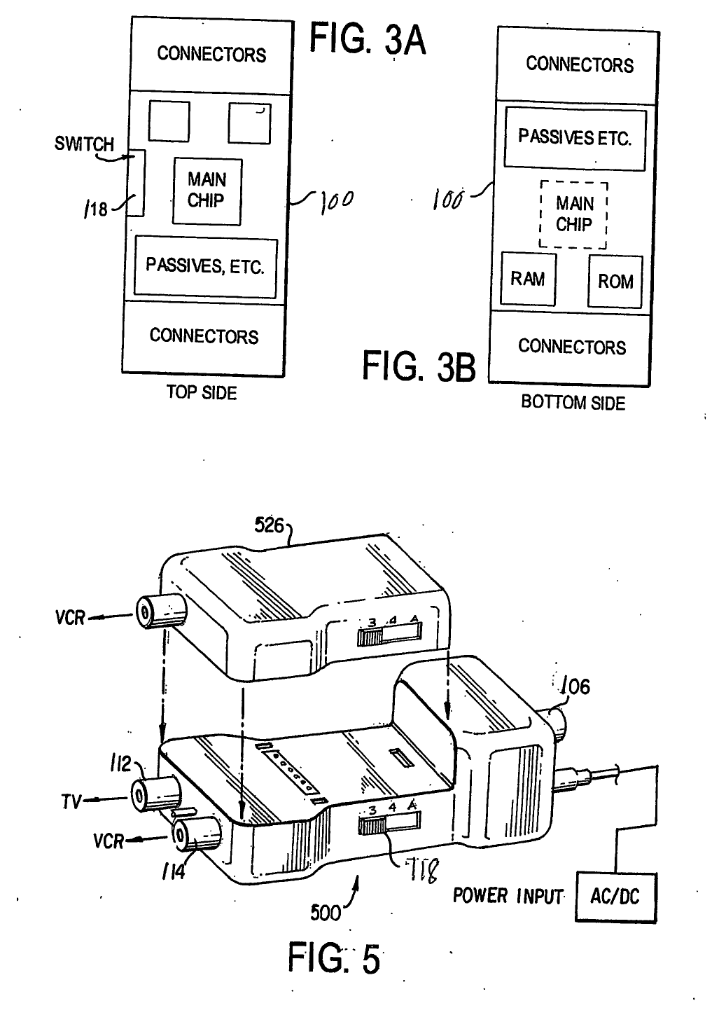

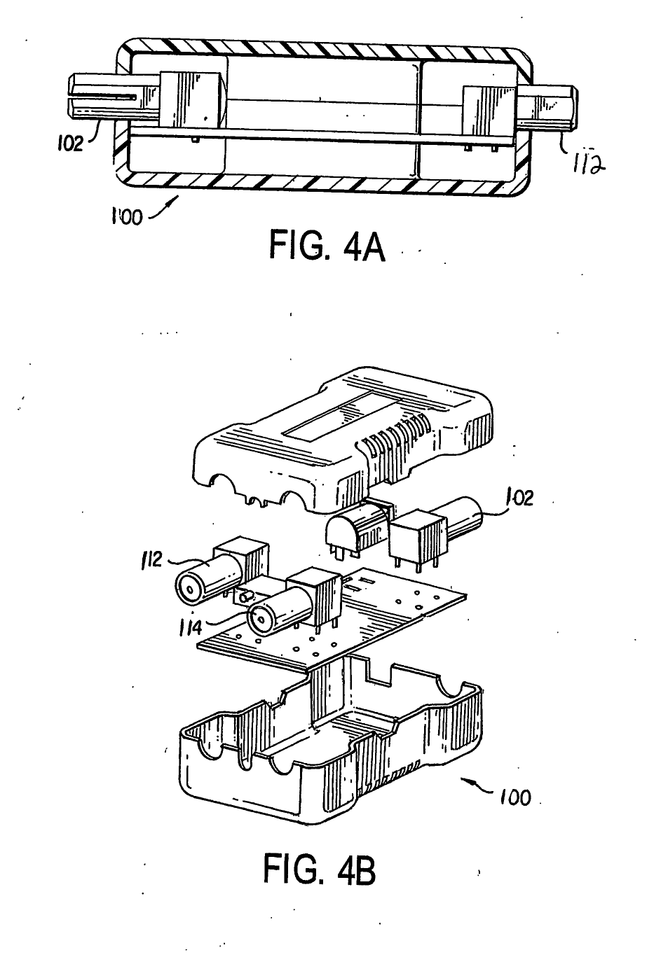

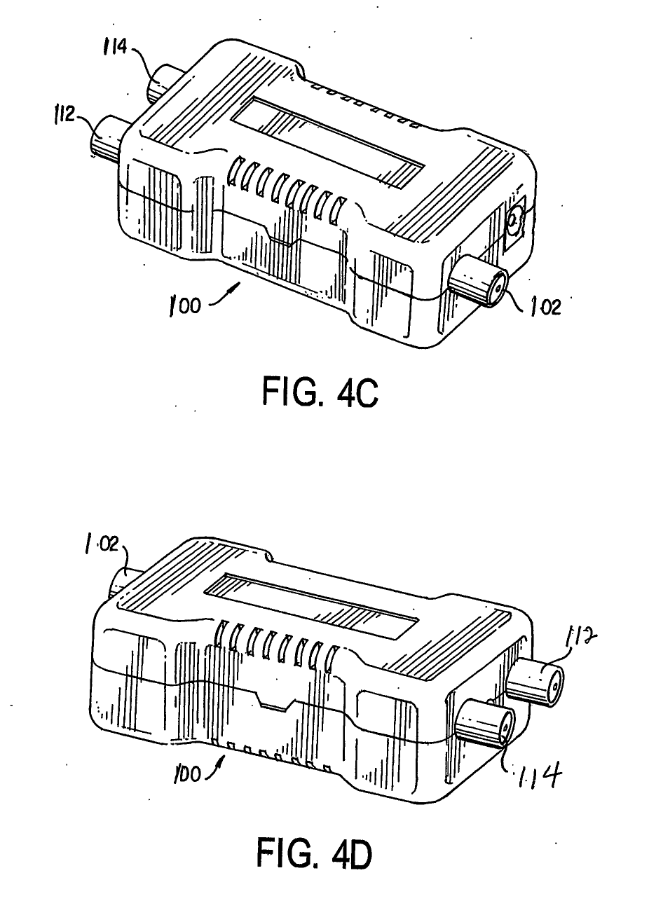

FIGS. 3A and 3B show a layout of components in the DCA 100: Indicated is a four layer circuit board, but any number of layers may be employed as required to accomplish a small form factor. FIGS. 4A-4D show perspective views of the assembly of the housing of the DCA 100. FIG. 5 shows a modification 500 in which the circuitry 526 for supplying the signal to the VCR is removably attached, both electrically and mechanically, to the rest of the DCA.

The DCA may be provided as a microprocessor chip 144 (FIG. 1), 244A (FIG. 2A), or 244B (FIG. 2B) with integrated circuits that can support PIP as they provide for two or more tuner paths. Many TVs with 2-tuner PIP will only have one RF input with an internal splitter for feeding its internal tuners. However, one will not be able to connect both RF outputs of the DCA 100 to the one input of a 2-tuner PIP TV. To address that issue, a modification provides for an RF output stage that can set one internal path to one channel (e.g., Channel 3) and the second internal path to another channel (e.g., Channel 4) and combine the two for output to one RF connector. Therefore, the one connector carries both channels 3 and 4. This allows the RF output to go into the RF input of a 2-tuner PIP TV, in which one tuner is set to channel 3 and the other, to channel 4. Now, the DCA 100 can provide PIP for 2-tuner PIP TVs. Since in many television markets, either channel 3 or channel 4 is assigned, another channel, such as channel 5, can be provided for selection by the customer. Any two channels can be used.

The DCA 200B of FIG. 2B accomplishes the above using the same configuration as in FIG. 2A, except with only one RF output 212 instead of the two shown in FIG. 2A. The one RF output 212 can be achieved through industry-known techniques for signal combining, either on chip (preferred) or in a separate circuit.

This also allows for one cable to route from the DCA 100 to the VCR to the TV as well, where the VCR can be set to channel 4 and the TV can be set to channel 3, thus eliminating the cost of the second RF connector and simplifying the cabling.

While preferred embodiments of the present invention have been set forth in detail above, those skilled in the art who have reviewed the present disclosure will readily appreciate that other embodiments can be realized within the scope of the present invention. For example, as noted above, QAM, MPEG and the like can be replaced with other technologies. Also, numerical values are illustrative rather than limiting, as is the shape of the device shown in FIGS. 4A-4D. Furthermore, while the preferred embodiments show two parallel conversion paths for the TV and the VCR or PIP, a device may implement a single conversion path Oust for the TV) or more than two conversion paths (for the TV, VCR and PIP or for additional components). All such modifications and variations are intended to be included herein within the scope of this disclosure and the present invention and protected by the following claims.

What is claimed is:

1. An adapter for connecting a source of digital or analog television signals to an analog television set, the adapter comprising:
an input for receiving the source of digital or analog television signals;
circuitry for converting the digital television signals to an analog format for display on the analog television set and for passing the analog television signals to the analog television set;
an output for outputting the analog format or the passed-through analog television signals to the analog television set; and
a switch, settable by a user or under software control, for controlling the circuitry for (a) converting the digital television signals to the analog format when the switch is in a first position and (b) passing the analog television signals through to the analog television set when the switch is in the second position.

2. The adapter of claim 1, wherein the switch can be set in a plurality of said first positions for outputting the analog format to different channels.

3. The adapter of claim 1, further comprising:
second circuitry, in parallel with the circuitry, for converting the digital television signals to the analog format; and
a second output for outputting the analog format to a second device such as a videotape recorder, a picture-in-picture component of the television set, or another television set.

4. The adapter of claim 3, further comprising an infrared transceiver for controlling the circuitry and the second circuitry.

5. The adapter of claim 4, wherein the infrared transceiver receives infrared signals from a remote control to control the circuit and the second circuit.

6. The adapter of claim 5, further comprising means for implementing a GUI for programming the VCR channel and scheduling commands to the IR Transmitter.

7. The adapter of claim 6, wherein the infrared transceiver sends IR proxy commands to the VCR.

8. The adapter of claim 4, further comprising a processor and memory for implementing a graphical user interface for controlling the second circuitry and the IR transceiver.

9. The adapter of claim 1, further comprising one-time programmable memory for holding certificates and keys for conditional access.

10. The adapter of claim 1, further comprising a SIM module for holding certificates and keys for conditional access.

11. The adapter of claim 1, further comprising more than two said circuits for outputting analog outputs to more than two devices.

12. The adapter of claim 3, wherein the second circuit is removably attachable mechanically and electrically to the rest of the adapter.

13. A method for permitting an analog television set to receive either digital or analog television signals, the method comprising:
(a) connecting an adapter between a source of the digital or analog television signals and the analog television set, the adapter comprising (i) an input for receiving the source of digital or analog television signals; (ii) circuitry for converting the digital television signals to an analog format for display on the analog television set and for passing the analog television signals to the analog television set; (iii) an output for outputting the analog format or the passed-through analog television signals to the analog television set; and (iv) a switch, settable by a user, for controlling the circuitry for (a) converting the digital television signals to the analog format when the switch is in a first position and (b) passing the analog television signals through to the analog television set when the switch is in the second position;
(b) to receive the digital signals, setting the switch to the first position; and
(c) to receive the analog signals, setting the switch to the second position.

14. The method of claim 13, wherein:
the source changes from sending the analog signals to sending the digital signals at a cut-off time; and
step (c) comprises setting the switch from the second position to the first position at the cut-off time.

15. The method of claim 13, f her comprising:
(d) providing an IR transceiver in, or in electrical communication with, the adapter;
(e) receiving commands in the IR transceiver from a remote control to control the adapter; and
(f) outputting commands from the IR transceiver to control a VCR.

16. A chip comprising: an input for receiving the source of digital or analog television signals; circuitry for converting the digital television signals to an analog format for display on the analog television set and for passing the analog television signals to the analog television set; an output for outputting the analog format or the passed-through analog television signals to the analog television set; and means for receiving a control signal, settable by a user or under software control, for controlling the circuitry for (a) converting the digital television signals to the analog format when the switch is in a first position and (b) passing the analog television signals through to the analog television set when the switch is in the second position.

17. The adapter of claim 3, wherein the output and the second output are provided as a single common output for use, e.g., with a picture-in-picture television.

18. The adapter of claim 17, wherein the circuitry and the second circuitry output at selectable channels.

19. The chip of claim 16, comprising two of said circuitries.

20. The chip of claim 19, wherein the two circuitries share a common output for use, e.g., with a picture-in-picture television.

21. The chip of claim 20, wherein the two circuitries output at selectable channels.

22. The adapter of claim 1, further comprising a housing, and wherein the input and the output are on opposite ends of the housing.
